(19) United States
(12) Patent Application Publication
(10) Pub. No.: US 2009/0214692 A1
(43) Pub. Date: Aug. 27, 2009

(54) HOT PRESS MOLD FOR MEA OF FUEL CELL

(75) Inventors: Hwa Feng Chang, Hsinchu (TW); Hsiang Po Tsai, Hsinchu (TW); Chung Ping Wang, Hsinchu (TW)

Correspondence Address: APEX JURIS, PLLC, 12733 LAKE CITY WAY NORTHEAST, SEATTLE, WA, 98125, US

(73) Assignee: OPTODISC TECHNOLOGY CORPORATION, Hsinchu (TW)

(21) Appl. No.: 12/169,338

(22) Filed: Jul. 8, 2008

(30) Foreign Application Priority Data
Feb. 27, 2008 (TW) 097106732

(51) Int. Cl. B28B 11/10

(52) U.S. Cl. 425/394

(57) ABSTRACT

A hot press mold for a MEA of fuel cell is provided. The hot press mold includes: a first mold including a first alignment part; a second mold including a second alignment part, being piled up a first electrode, a film, and a second electrode on it, whereby the first and second alignment parts join together to pile the first electrode, the film, and the second electrode between the first and second mold; and a lock loop secures the edge of the first and second mold to fix the first and second mold.

### CROSS-REFERENCES TO RELATED APPLICATIONS

This non-provisional application claims priority under 35 U.S.C. §119(a) on Patent Application No(s). 097106732 filed in Taiwan, R.O.C. on Feb. 2, 2008, the entire contents of which are hereby incorporated by reference.

### FIELD OF INVENTION

This invention relates to a hot press mold, and more particularly to a hot press mold for the membrane electrode assembly (MEA), of a fuel cell.

### BACKGROUND

The natural resources of the earth diminish with the fast development of global industries, forcing the energy engineering industry to increase efforts to research an energy technology with the advantages of low-pollution, reusability and high conversion rate. Thus fuel cells, having a high energy conversion rate, become the focus of attention. Out of every kind of fuel cell, proton exchange membrane fuel cells (PEMFC) are the most popular, due to their fast activation, low activation temperature, higher power density and no electrolyte corrosion or leakage.

The main structure of PEMFC is the MEA which consists of the membrane, the electrodes, and the gas diffusion layers. The first step of the hot press process is to place the anode (or cathode) on the heatsink. The second is to pile the proton exchangeable membrane, cathode (or anode) and the heatsink on the previous electrode in sequence. The last is to place another heatsink on the top side and put the whole assembly onto a machine which has been pre-heated to the setting temperature. The machine compresses and heats the whole assembly so that the electrodes and the proton exchangeable membrane will adhere to each other to form the MEA. After the compressing and heating process are completed, the machine starts to cool down. As the cooling process is completed, the MEA can be removed from the heatsink.

However, this method of manufacturing MEA has the following problems. During the piling process, movement occurs between the electrodes and the membrane that results in a dimension deviation of the MEA. In addition, the hot press process could also cause such movement to occur during assembly. Furthermore, the MEA must be cooled down under a constant compressing pressure to prevent dimension distortions and undesirable adhering problems. Thus the conventional manufacturing method of MEA has a long cycle time and is inefficient. Furthermore, the repeated heating-cooling and continuous compressing process will increase process time and decrease the lifetime of the machine.

Therefore, the primary issues to be solved are improving the structure of the hot press mold to make each component of the assembly align more easily, ensuring the MEA can be cooled outside the machine (reducing cooling time), and increasing the lifetime of the hot press machine by avoiding a repetitious heating-cooling process.

### SUMMARY

In view of these problems, this invention presents a hot press mold for the MEA of a fuel cell including: a first mold, a second mold, and a lock loop, wherein the first mold includes a first alignment part, and the second mold includes a second alignment part. A first electrode, a membrane and a second electrode are piled onto the second mold. The first alignment part connects with the second alignment part to combine the first mold with the second mold, which positions the first electrode, the membrane and the second electrode between the first mold and the second mold. The lock loop secures the edge of the first mold and the second mold and consequently fixes the first mold and the second mold.

The second mold has an electrode alignment groove and a membrane alignment groove to accommodate the second electrode and the membrane individually, and the first electrode is placed on the membrane through an electrode alignment plate. So each component of the assembly is piled up more easily and more accurately, and the dimension of the assembly is not influenced by the movement occurring between the first mold and the second mold.

Due to the fact that there are several first electrodes, membranes and second electrodes to be placed between the first mold and the second mold, several MEAs are manufactured at the same time and production efficiency is improved significantly.

Furthermore, after heating the first mold and the second mold completely, the lock loop is rotated to shorten the distance between the first mold and the second mold, which can then be moved elsewhere to cool, thus reducing significantly the MEA production process time. Furthermore, a circulating fluid can be placed in the first mold or the second mold or both to improve cooling efficiency.

The preferred embodiments and effects related to the present invention will be described in detail with the following figures.

### BRIEF DESCRIPTION OF THE DRAWINGS

The following detailed description of the embodiments of the present invention can be best understood when read in conjunction with the following drawings, in which device parts are identified with reference numerals and in which:

FIG. 1A is an outline diagram of the assembly of the first embodiment;

FIG. 1B is an exploded diagram of the first embodiment.

FIG. 2A is a structure diagram of the first mold of the first embodiment.

FIG. 2B is a structure diagram of the second mold of the first embodiment.

FIG. 2C is a structure diagram of the electrode alignment plate of the first embodiment.

FIG. 2D is a structure diagram of the lock loop of the first embodiment.

FIG. 3A is a cross-section diagram of the assembly of the second embodiment (1).

FIG. 3B is a cross-section diagram of the assembly of the second embodiment (2).

FIG. 4A is a structure diagram of the second mold of the third embodiment.

FIG. 4B is a structure diagram of the electrode alignment plate of the third embodiment.

FIG. 5 is a structure diagram of the second mold of the fourth embodiment.

FIG. 6 is a structure diagram of the second mold of the fifth embodiment.

FIG. 7 is a structure diagram of the lock loop of the sixth embodiment.

FIG. 8A is a structure diagram of the first mold of the seventh embodiment.

FIG. 8B is a structure diagram of the second mold of the seventh embodiment.

### DETAILED DESCRIPTION

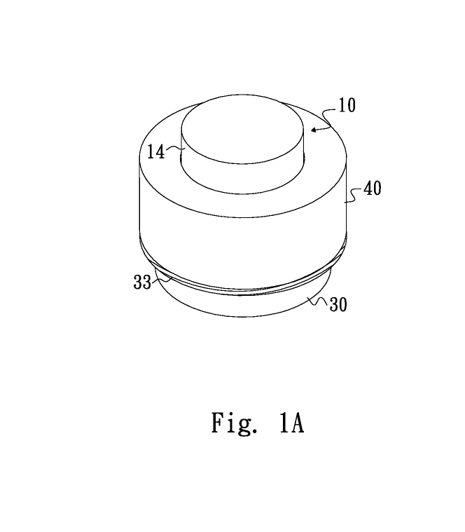

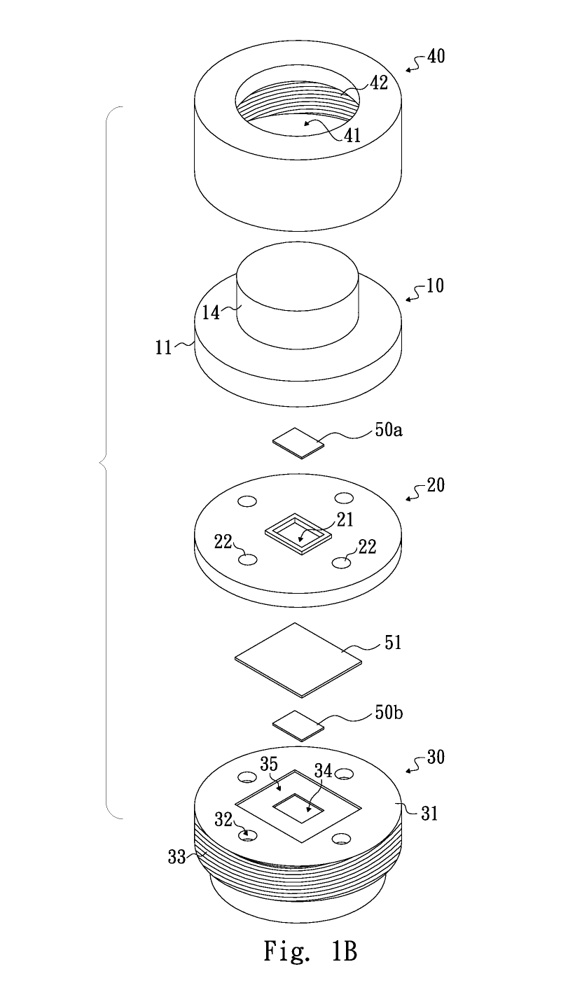

Please refer to FIG. 1A, 1B, 2A, 2B, 2C and 2D, which is the first embodiment of the present invention, wherein FIG. 1A is a diagram of the assembly's outline, FIG. 1B is an exploded diagram; FIG. 2A is a structure diagram of the first mold, FIG. 2B is a structure diagram of the second mold; FIG. 2C is a structure diagram of the electrode alignment plate; FIG. 2D is a structure diagram of the lock loop.

The hot press mold for MEA of fuel cell includes: the first mold 10, the second mold 30 and the lock loop 40.

The first mold 10 has a body 11 which is substantially round, a plurality of first alignment parts 12 set on one surface of the body 11, and a projection 14 set on the other surface of the body 14.

The second mold 30 has a body 31 which is substantially round, a plurality of second alignment parts 32 set on the body 31, and a second external thread 33 is set at the outer surface of the body 31. In addition, an electrode alignment plate 34 and a membrane alignment groove 35 are set on the body 31, and a part of the area of the membrane alignment groove 35 overlaps the electrode alignment groove 34.

The above-mentioned first alignment part 12 can be a first alignment pin, and the second alignment part 32 can be a second alignment hole. When the first mold 10 is combined with the second mold 30, the first alignment pin is inserted into the second alignment hole to position the first mold 10 on the second mold 30. In addition, the first alignment part 12 can be a first alignment hole, and the second alignment part 32 can be a second alignment pin. When the first mold 10 is combined with the second mold 30, the second alignment pin will be inserted into the first alignment hole to position the first mold 10 on the second mold 30. The following description takes the first alignment part 12 as the first alignment hole, the second alignment part 32 as the second alignment pin.

The lock loop 40 is substantially round, the central part is a through-hole 41, and the inner surface of the lock loop 40 has an inner thread 42 which matches with the second outer thread 33. The lock loop 40 secures the edge of the first mold 10 and the second mold 30 so that the first mold 10 and the second mold 30 can be fixed.

An optional first outer thread (not shown) may be added to the outer surface of the body 11 of the above-mentioned first mold 10, where the first outer thread matches with the inner thread 42. The first outer thread is used to fix the first mold 10 and the lock loop 40.

The hot press mold of the fuel cell MEA further includes an electrode alignment plate 20 placed between the first mold 10 and the second mold 30, which has an electrode guiding tunnel 21 and a plurality of through-holes 22. The second alignment part 32 passes through the through-hole 22 and is inserted into the first alignment part 12.

The first step of manufacturing the MEA is to place the second electrode 50b into the electrode alignment groove 34 and to place the membrane 51 into the membrane alignment groove 35. Next, the electrode plate 20 is piled on the second mold 30 and the first electrode 50a is piled on the membrane 51 through electrode guiding tunnel 21. The first electrode 50a, membrane 51 and the second electrode 50b pile on the second mold 30 in sequence, and the electrode alignment plate 20 can subsequently be removed. Then, the first mold 10 is stacked on the second mold 30, while the second alignment part 32 passes through the through-hole 22 and is inserted into the first alignment part 12 to position first electrode 50a, membrane 51 and the second electrode 50b between the first mold 10 and the second mold 30. Next the lock loop 40 is hitched to the first mold 10 and the second mold 30 and the projection 14 of the first mold 10 lodges in the through-hole 41 of the lock loop 40. Finally the lock loop 40 is rotated to tighten the first mold 10 and the second mold 30.

The top surface of the projection 14 is higher than the top surface of the body 11, but it is not a restriction on the present invention. In addition, the above-mentioned membrane 51 is a proton exchangeable membrane, but it is not a restriction on the present invention.

After completing the above-mentioned steps, the whole assembly is hot pressed in the hot press machine. If the top surface of the projection 14 is higher than the body 11, then the hot press machine will press the MEA through the projection 14. So the first electrode 50a, the membrane 51 and the second electrode 50b adhere to each other to form the MEA. After completing the hot press process, lock loop 40 is rotated to tighten the first mold 10 and the second mold 30 and the whole assembly is removed from the hot press machine to cool. The cooling method for the hot-pressed assembly includes: water cooling, air cooling and contact cooling. After the assembly is cooled down, the lock loop 40 is loosened to separate the first mold 10 from the second mold 30. The MEA is then removed from the first mold 10 and second mold 30. Since the cooling process is not executed in the hot press machine, the present invention avoids the problem of overlong process time, and also increases the lifetime of the hot press machine. Furthermore, the present invention aligns first electrode 50a, the membrane 51, and the second electrode 50b more easily and accurately.

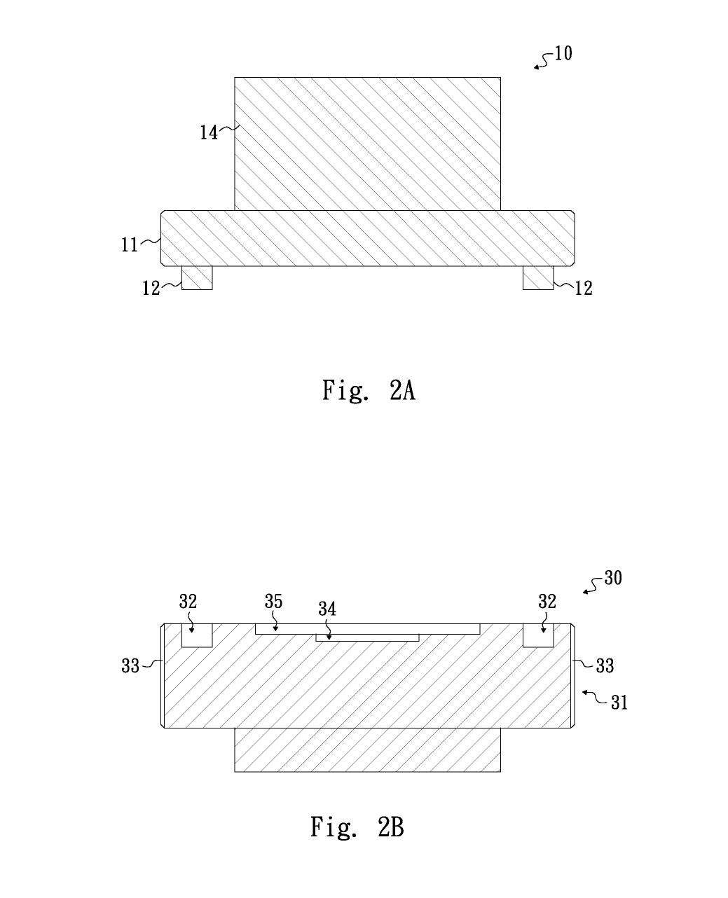

Please refer to FIG. 3A and FIG. 3B, which are the second embodiment of the present invention, where FIG. 3A is a cross-section diagram of the assembly (1) and FIG. 3B is a cross-section diagram of the assembly (2).

In the present embodiment the projection 15 which is corresponds to the electrode guiding tunnel 21 is placed on one of the surface of the body 11 of the first mold 10. The size of the projection 15 is matched with the electrode guiding tunnel 21 (as shown in FIG. 3A). First, the electrode alignment plate 20, the first electrode 50a, the membrane 51 and the second electrode 50b are piled on the second mold 30 in sequence. Secondly, the first mold 10 is stacked on the second mold 30 and the second alignment part 32 passes through the through-hole 22 and is inserted into the first alignment part 12 to position the first electrode 50a, the membrane 51 and the second electrode 50b between the first mold 10 and the second mold 30, while the projection 15 is plugged into the electrode guiding tunnel 21 and presses the first electrode 50a.

Furthermore, the cross-section area of the projection 15 is between that of the electrode alignment groove 34 and the membrane alignment groove 35 (as shown in FIG. 3B). The height of the projection 15 is longer than the sum of the depth of the electrode alignment groove 34 and the membrane alignment groove 35. First, the electrode alignment plate 20 is stacked on the second mold 30. Second, the first electrode 50a, the membrane 51 and the second electrode 50b are piled in sequence, and the electrode alignment plate 20 is subsequently removed. Third, the first mold 10 is stacked on the second mold 30. Finally, the second alignment part 32 is passed through the through-hole 22 and inserted into the first alignment part 12 to position the first electrode 50a, the membrane 51 and the second electrode 50b between the first mold 10 and the second mold 30.

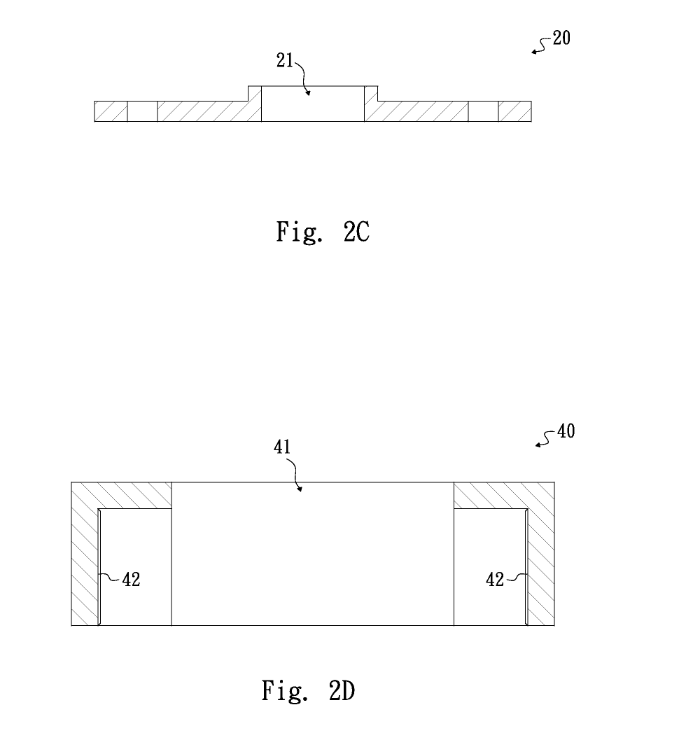

Please refer to FIG. 4A and FIG. 4B, which constitute the third embodiment of the present invention. FIG. 4A is a structure diagram of the second mold and FIG. 4B is a structure diagram of the electrode alignment plate.

In the present embodiment the top of the body 31 of the second mold 30 has a plurality of the electrode alignment grooves 34 and the membrane alignment grooves 35. The electrode alignment plate 20 has a plurality of the electrode guiding tunnels 21 corresponding to the electrode alignment grooves 34, wherein the number of the electrode alignment groove 34, the membrane alignment grooves 35 and the electrode guiding tunnels 21 depends on the requirement. The purpose of the present embodiment is to manufacture several MEAs at the same time and improve the production efficiency significantly.

The first mold 10 has a plurality of projections 15, corresponding to the electrode guiding tunnels 21, for pressing the first electrode 50a in each of the electrode guiding tunnel 21.

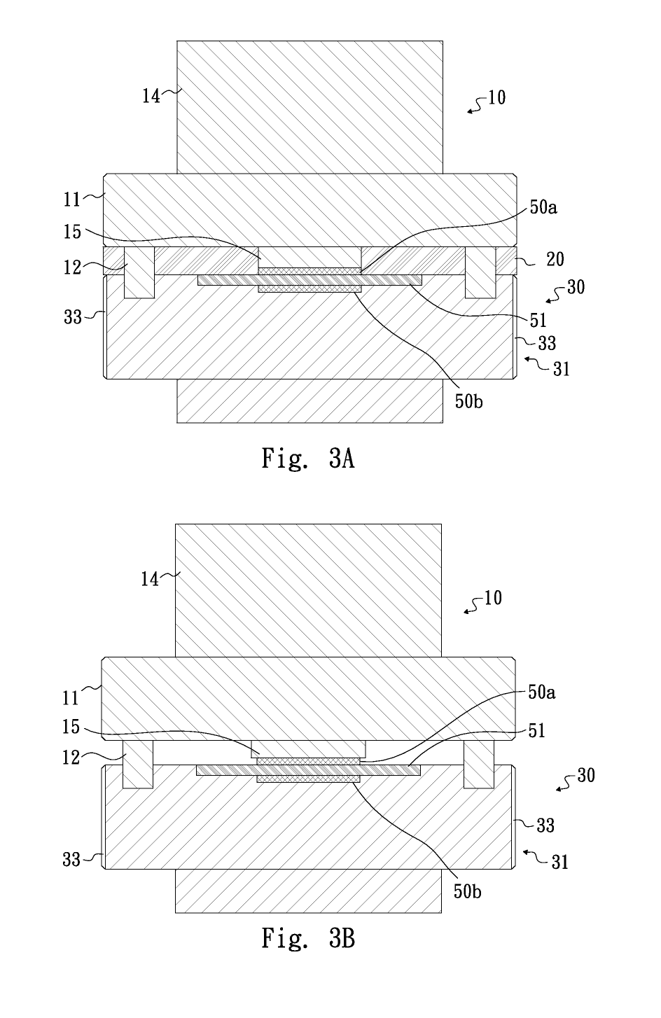

Please refer to FIG. 5, which is a structure diagram of the second mold of the fourth embodiment, wherein the body 31 of the second mold 30 has a plurality of trenches 36, connecting the electrode alignment groove 34 and the membrane alignment groove 35 to the outer space, to release the gas generated during the hot press process. If the second mold 30 only has the electrode alignment groove 34, the trench 36 only connects the electrode alignment groove 34 to the external space to release the gas generated during hot press process.

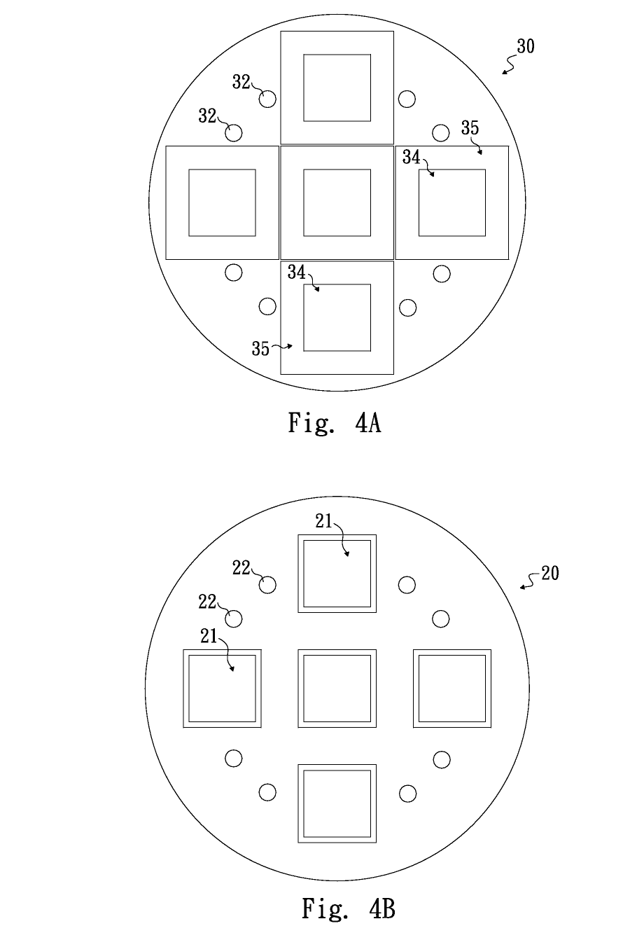

Please refer to FIG. 6, which is a structure diagram of the second mold of the fifth embodiment of the present invention. The external surface of the body 31 of the second mold 30 has a plurality of inserting-holes. By inserting a specific tool into the inserting-holes, the assembly may be moved easily and safely.

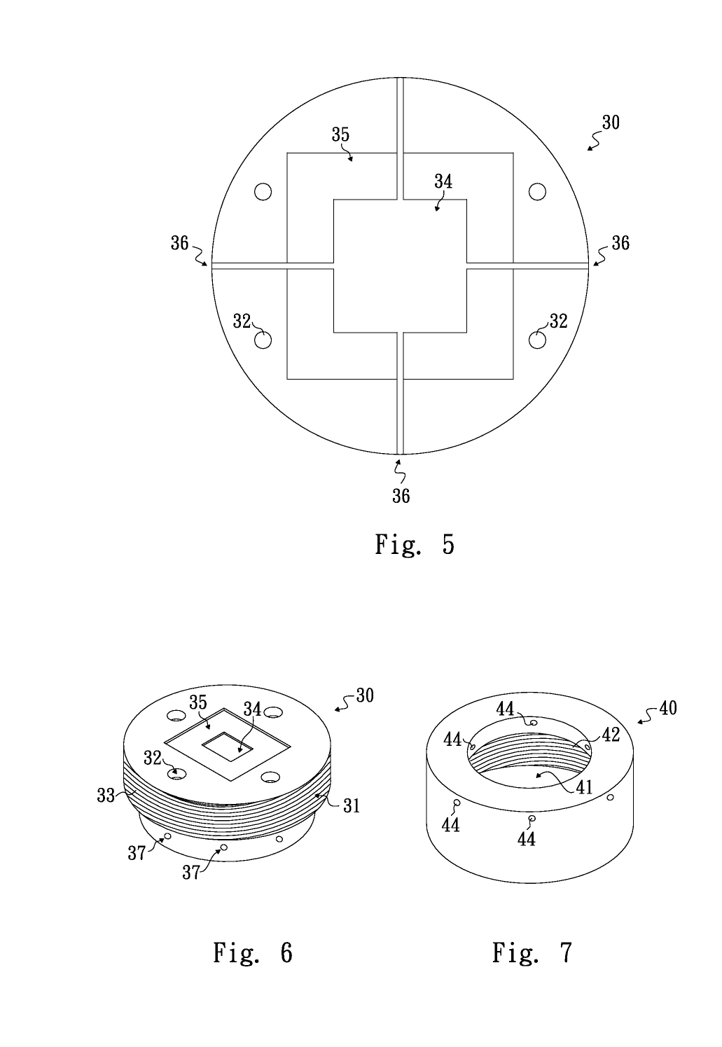

Please refer to FIG. 7, which is a structure diagram of the lock loop of the sixth embodiment. The outside surface of the lock loop 40 has a plurality of plugging-holes 44. By inserting a specific tool into the plugging-holes 44, the lock loop 40 may be rotated easily to tighten the first mold 10 and second mold 30, while tightening the first electrode 50a, the membrane 51, and the second electrode 50b.

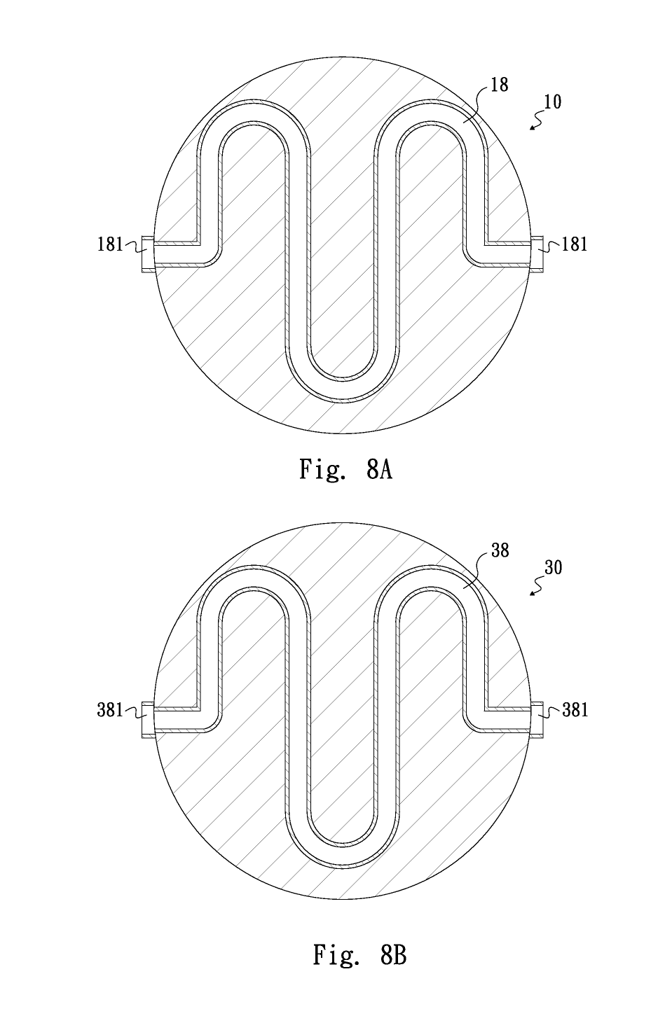

Please refer to FIG. 8A and FIG. 8B, which is the seventh embodiment of the present invention, wherein, FIG. 8A is a structure diagram of the first mold and FIG. 8B is a structure diagram of the second mold.

In order to improve the cooling effect, a first channel 18 is cut zigzag in the body 11 of the first mold 10. Both ends of the first channel 18 have a first connector 181 for connecting a pipe which allows cooling liquid to flow in and transfer the heat. A second channel 38 is cut zigzag in the body 31 of the second mold 30. Both ends of the second channel 38 have a second connector 381 for connecting a pipe which allows cooling liquid to flow in and transfer the heat. The present embodiment improves the cooling effect and shortens the time required for cooling.

The above-mentioned description is not used to limit the present invention. Though the embodiment of setting both of the first channel 18 and the second channel 38 is described above, the first channel 18 may alternatively be set in the first mold 10 and in the second mold 30. The second channel 38 is optional.

The technical contents of the present invention have been disclosed with preferred embodiments as above. However, the disclosed embodiments are not used to limit the present invention. Those proficient in the relevant fields could make slight changes and modification without departing from the spirit of the present invention, and the changes and modification made thereto are all covered by the scope of the present invention. The protection scope for the present invention should be defined with the attached claims.

What is claimed is:

1. A hot press mold for MEA of fuel cell, comprising:
a first mold, comprising at least a first alignment part;
a second mold, comprising at least a second alignment part, wherein a first electrode, a membrane and a second electrode are stacked on the second mold in sequence, the first alignment part connects with the second alignment part to combine the first mold and the second mold, which positions the first electrode, the membrane and the second electrode between the first mold and the second mold; and
a lock loop, hitching the outside surface of the first mold and the second mold, and consequently fasten the first mold and the second mold.

2. The hot press mold of claim 1, wherein the first alignment part is a first alignment pin, the second alignment part is a second alignment hole, the first alignment pin connects the second alignment hole to combine the first mold and the second mold.

3. The hot press mold of claim 1, wherein, the first alignment part is a first alignment hole, the second alignment part is a second alignment pin, the second alignment pin connects the first alignment hole to combine the first mold and the second mold.

4. The hot press mold of claim 1, wherein the first mold further comprises a projection, the lock loop comprises a through-hole, and the projection is inside the through-hole when the lock loop secures the first mold.

5. The hot press mold of claim 1, wherein one surface of the projection is coplanar to one surface of the lock loop.

6. The hot press mold of claim 1, wherein a part of the projection is not inside the through-hole.

7. The hot press mold of claim 1, wherein the first mold further comprises at least a first tunnel and a plurality of first connectors, the first connectors being located at both ends of the first tunnel to connect a pipe which allows cooling liquid to flow in.

8. The hot press mold of claim 1, wherein the first mold further comprises at least a projection for pressing the first electrode as the first mold combines with the second mold.

9. The hot press mold of claim 1, wherein the first mold further comprises a first outer thread, and the lock loop comprises an inner thread which corresponds to the first outer thread.

10. The hot press mold of claim 1, wherein the second mold further comprises a second outer thread and the lock loop comprises an inner thread which corresponds to the second outer thread.

11. The hot press mold of claim 1, wherein the second mold further comprises at least an electrode alignment groove for accommodating the second electrode.

12. The hot press mold of claim 1, wherein the second mold further comprises at least a trench for releasing gas when combining the first mold and the second mold.

13. The hot press mold of claim 1, wherein the second mold further comprises at least a membrane alignment groove for accommodating the membrane.

14. The hot press mold of claim 1, wherein a part of the area of the membrane alignment groove overlaps the electrode alignment groove.

15. The hot press mold of claim 1, wherein the second mold further comprises at least a trench for releasing gas when combining the first mold and the second mold.

16. The hot press mold of claim 1, wherein the second mold further comprises at least a second tunnel and a plurality of second connectors, and the second connectors locate at the both ends of the second tunnel for connecting a pipe which allows cooling liquid to flow in.

17. The hot press mold of claim 1, wherein the second mold further comprises at least an inserting-hole for allowing a specific tool to insert in to move the second mold.

18. The hot press mold of claim 1, wherein the lock loop comprises at least a plugging-hole for allowing a specific tool to insert in to rotate the lock loop.

19. The hot press mold of claim 1 further comprises an electrode alignment plate and at least an electrode guiding tunnel, the electrode alignment plate locates between the first mold and the second mold, and the electrode guiding tunnel for guiding the first electrode as it is piled on the membrane, is located on the top of the electrode alignment plate.

20. The hot press mold of claim 19, wherein the electrode alignment plate comprises at least a through-hole, and one of the first alignment part and the second alignment part passes through the through-hole to combine the first alignment part with the second alignment part.
